(19) United States
(12) Patent Application Publication
(10) Pub. No.: US 2026/0320304 A1
(43) Pub. Date: Oct. 15, 2026

(54) PERSONALIZED CONTENT GENERATION VIA ADAPTIVE LANGUAGE MODELS

(71) Applicant: GOOGLE LLC, Mountain View, CA (US)

(72) Inventors: Antonio Gaetani, Kilchberg (CH); Patrick Andreas Zoechbauer, Zurich (CH); Carsten Isert, Zurich (CH); Mugurel-Ionut Andreica, Adliswil (CH); Martin Baeuml, Wollerau (CH); Kyle Gerard, Zurich (CH)

(21) Appl. No.: 19/209,622

(22) Filed: May 15, 2025

Related U.S. Application Data
(60) Provisional application No. 63/788,539, filed on Apr. 14, 2025.

(51) Int. Cl. G06F 40/40; G06F 40/279

(52) U.S. Cl. CPC G06F 40/40; G06F 40/279

(57) ABSTRACT

Implementations herein relate to a process that can include identifying context characteristics related to intended message recipients based on a user's input. User-specific conditioning data (USCD) is identified from previous digital interactions, relating to these context characteristics. The process can include identifying tonal characteristics within this USCD. A generative model then creates digital content incorporating these tonal characteristics, which is transmitted to the intended recipients, thereby personalizing the communication. Other implementations may be described and/or claimed.

### CROSS-REFERENCE TO RELATED APPLICATIONS

The present application claims priority to US Provisional Application 63/788,539, filed Apr. 14, 2025, the contents of which are incorporated herein in their entirety.

### BACKGROUND

Legacy language models are often trained using broad training datasets that can capture general linguistic patterns, but may not account for the nuances of individual communication styles. As a result, early systems, while capable of generating coherent text, can produce generic and non-personalized outputs.

Subsequent advancements explored techniques such as fine-tuning to tailor models to specific tasks or domains. While fine-tuning can improve performance on targeted tasks, it can also necessitate substantial amounts of labeled data, which may not allow for a desirable level of adaptability. Moreover, the computational cost of fine-tuning individual models for each user can be prohibitive.

Another approach can involve incorporating user-specific data, such as past interactions, to personalize responses. However, such systems can struggle to effectively integrate this information into the generation process, resulting in outputs that can feel disjointed or inconsistent with the user's established communication patterns. Retrieval-based methods, for example retrieval augmented generation (RAG), which fetch and incorporate relevant examples from a user's data, can also suffer from limitations in accurately identifying and selecting the most appropriate examples, leading to suboptimal personalization.

Some example implementations disclosed herein can be directed to a process that identifies, based on an input received from a user, one or more context characteristics that are related to one or more intended recipients of digital content (e.g., an email, a text message, and/or some other message) that is to be delivered to the one or more intended recipients. The process can further include identifying a portion of user-specific conditioning data (USCD) that is associated with the user based on the one or more context characteristics. The USCD can be based on one or more previous digital interactions of the user with one or more electronic devices, and the previous digital interactions can be related to the one or more context characteristics. For example, the one or more context characteristics can relate to an identity of a recipient, type of relationship between the user and the recipient(s), a language spoken by the user and/or the recipient(s), the subject matter of the digital content, the method of delivery of the digital content (i.e., a text message, an email, a professional memorandum, etc.), and/or some other characteristic or attribute of the sender and/or recipient.

In some implementations, the previous digital interactions can be or relate to a written interaction such as an email, a text message, a social media post, a chat message, or some other interaction where the user has expressed themself in a written format. Additionally or alternatively, the previous digital interactions can be or relate to some other type of digital content such as a photograph taken by or includes the user, a video that is taken by or includes the user, audio spoken by or to the user, etc.

The process can also include identifying one or more tonal characteristics of the one or more previous digital interactions based on the portion of the USCD. For example, the tonal characteristic(s) can be associated with the one or more context characteristics. The tonal characteristic(s) can include, for example, sentiment (e.g., positive, neutral, negative), shared experiences, writing style elements such as the use of emojis, the use of humor, the degree of conciseness or professionalism, the use of nicknames as opposed to formal names, specific vocabulary choice, the use of bulletpoints or full sentences, etc. The process can further include causing the generative model to generate content such as the digital content based on the query and the portion of the user-specific conditioning data. For example, the digital content can have the previously-identified tonal characteristic(s). The process can further include transmitting the digital content to the one or more intended recipients.

In some implementations, based on the context characteristics, the system can identify the previous digital interactions and generates the user-specific conditioning data based on those interactions. For instance, if the context characteristic is a professional relationship with a recipient, the system can use tonal characteristics taken from sources such as past emails, memos, or documents created in a professional context to generate the user-specific conditioning data.

In some implementations, context characteristics can be related to a relationship between the user and the one or more intended recipients, such as a professional relationship, a personal relationship, a familial relationship, the closeness of the relationship (e.g., a close friend as opposed to a casual acquaintance), a formal relationship, etc. For example, when generating an email to a supervisor, the context characteristic can be a professional relationship, while when generating a text message to a family member, the context characteristic can be a personal or familial relationship.

In some implementations, context characteristics can additionally or alternatively relate to a language spoken by the user or the intended recipient. For example, if the user communicates with one recipient in English and another in Spanish, the context characteristic can be the language preference of the recipient. In still other implementations, the context characteristics relate to a method of delivery to be used to transmit the digital content. For example, tone or style can be different if the method of delivery is an email instead of a text message.

In some implementations, the context characteristics could relate to other characteristics of one or more intended recipients of the digital content. For example, as described below, the context characteristics could relate to a level of expertise of one or more recipients, a level of access or clearance of the one or more recipients, history of the one or more recipients, etc.

In some implementations, previous digital interactions could include one or more written interactions such as a previous written message sent to the intended recipients, or a previous written message sent to another recipient that is related to the one or more context characteristics. For example, the system might examine previous emails sent to a specific client, or it might consider emails sent to similar clients in the same industry. These previous written interactions can include an email or document at least partially written by the user, a search engine query formulated by the user, or a social media post of the user. For instance, the system could analyze emails, word processing documents, past search queries, or posts on social media to determine the user's writing style and vocabulary.

In some implementations, tonal characteristics can relate to vocabulary that is present in the previous written interactions, a degree of conciseness in the previous written interactions, various sentiments that are detected in previous written interactions (e.g., using various sentiment analysis techniques such as natural language processing, computational linguistics, etc.), or the use of contractions in the previous written interactions. They could additionally or alternatively relate to the use of humor or the use of emojis in the previous written interactions. For example, in some implementations, the system could identify that a user frequently uses certain words or phrases when communicating with a specific person, or that they tend to be more concise in their emails to coworkers than in their messages to friends. The system could also note whether the user typically uses contractions or avoids them, and whether they include jokes or emojis in their communications.

In some implementations, the tonal characteristics can relate to information presented in the digital content. For example, the types of information, the style of information presentation, what types of information are prioritized, etc.

It will be understood that the above examples of elements such as tonal characteristics, context characteristics, and digital interactions are intended for the sake of non-limiting example only. Other implementations could include various additional or alternative characteristics. Additionally, while many examples described herein related to users interacting with generative model-powered automated assistants, this is not meant to be limiting. Techniques described herein are applicable outside of the automated assistant context. For example, techniques described herein may enable users of AI-powered productivity software, such as word processors, spreadsheets, presentation programs, etc., to have increasingly bespoke experiences. As another example, users engaging with a general-purpose generative model interaction interface (e.g., not specifically an automated assistant) such as might be provided via a web browser may benefit from techniques described herein.

Some implementations disclosed herein can reduce or eliminate various drawbacks associated with one or more of the above-described legacy techniques. Such drawbacks can include or relate to struggling to personalize content effectively, struggling to adapt to new users, and/or struggling to efficiently integrate user-specific data. For example, in accordance with implementations described herein, a system's ability to build a comprehensive user profile offline and dynamically retrieve relevant examples at runtime can enable more accurate and personalized content generation. As another example, by leveraging both an understanding of the user (based on the user's built and/or pre-existing profile(s)) and concrete examples of their past writing and/or other digital communication, the system can generate responses that closely resemble the user's own communication patterns, thereby avoiding the disjointedness and inconsistency found in existing systems. As another example, the system's retrieval augmented generation (RAG) process, enhanced by user summaries and relational information, can improve the accuracy and relevance of retrieved examples, thereby overcoming the limitations of RAG systems that struggle to select the most appropriate data.

As a non-limiting example of some implementations disclosed herein, consider a user, Alice, who frequently communicates with both her supervisor, Bob, and her close friend, Carol. Alice can use a generative AI model integrated into her email application. One day, Alice receives an email from Bob requesting a project status update. Alice could choose to ask the system to use the generative AI model to prepare a response to Bob. Based on Alice’s request, the system could identify Bob as the recipient and, and so recognize context characteristics related to Bob such as a professional relationship (for example, wherein Bob is in the role of a supervisor of Alice). Based on this recognized context characteristic, the system can access at least a portion of the USCD associated with Alice. Specifically, the system can access the portion of USCD that is associated with Alice's previous communications in a professional setting. This USCD can be built from previous written interactions by Alice with Bob and/or another individual with whom Alice professionally interacts. Such communications can include items such as previous emails of Alice, documents or memos that are written by Alice, or other written documents.

In some implementations, at least a portion of the USCD can already be retrieved, analyzed, and or stored by the system, for example in some form of non-volatile computer memory. In other implementations, the system can utilize a RAG process to search various data sources associated with Alice (e.g., her email client's "sent items" folder, an online file-storage drive, or other sources) to identify and/or retrieve data for the USCD. The USCD can indicate, for example, that Alice typically adopts tonal characteristics such as a formal and concise tone when communicating with Bob. The generative model can then be used to generate output that is conditioned on a similar style and tone for the email to Bob, mirroring the structure and formality of Alice's previous emails, and autocomplete the email by, for example, providing a bullet-point summary of project progress.

In contrast, when Alice composes an email to Carol inviting her to a concert, the system can go through a similar process wherein the system can recognize that Carol is an intended recipient of the email, and so recognize context characteristics related to Carol such as a close friendly relationship. Based on this recognized context characteristic, the system can access at least a portion of the USCD associated with Alice that is associated with Alice's previous communications to a close friend. Such previous communications can include, for example, emails to Carol, emails to another close friend, and/or other data sources. The USCD can indicate that Alice uses tonal characteristics such as a casual and humorous communication style. Accordingly, the generated email to Carol can include emojis and a conversational tone, reflecting Alice's typical communication style with her friend. This example illustrates how the system effectively personalizes content generation by adapting to the recipient and context, leveraging both user profile information and dynamically retrieved examples of past communications.

In another implementation, a context characteristic could relate to a level of proficiency or expertise of the recipient with regards to a task that is related to the digital content. For example, if a user is generating digital content (i.e., writing an email or memorandum) that explains how to perform a task that requires advanced knowledge or expertise, then the tonal characteristics of that content could differ based on the knowledge level of the recipient. In a more specific example, Alice, a network engineer, is tasked with creating documentation for setting up a new network firewall. If the intended recipient of the documentation is another experienced network engineer, the tonal characteristics might include technical jargon, concise explanations assuming a base level of knowledge, and a focus on advanced configuration options. In contrast, if the documentation is intended for a layperson with minimal technical background, the tonal characteristics could differ significantly. The language would be simplified, technical terms would be defined, and the documentation could include step-by-step instructions with visual aids to guide the user through the process.

In another example, consider an example scenario where a user is generating a user interface (UI) for a web application designed for internal company use. David prompts the system to "create a dashboard for tracking project milestones and resource allocation." The system can then tailor the complexity and sensitivity of the UI based on its understanding of the intended audience. For example, the intended audience could have context characteristics that indicate that they are senior executives, have a high security clearance, have a high level of decision making capability, etc. Based on these context characteristics, the system can identify, via the USCD, that content for individuals with these characteristics can include information related tonal characteristics such as detailed financial data, access to sensitive project documents, and interactive elements for drilling down into specific project metrics. In addition, the system could identify that content for these individuals should be professional and concise, prioritizing data clarity and strategic insights.

Conversely, if the intended audience is junior team members with limited technical expertise, the UI would be simplified, focusing on high-level progress indicators, task assignments, and easy-to-understand visualizations. The sensitive financial data would be omitted, and access to project documents would be restricted based on their roles. The tone would be encouraging and supportive, emphasizing ease of use and clear communication. The system could incorporate tooltips and contextual help to guide less technically inclined users. This exemplifies how the system dynamically adjusts the UI's features, content, and overall presentation based on the intended audience's trust level and technical proficiency, as learned through analysis of David's previous interactions and specified audience characteristics.

In another implementation, consider the scenario of a user, Emily, who is planning her wedding. Emily uses a generative AI model to create personalized maps for her wedding guests. The system can identify context characteristics related to the guests to tailor the map content.

For local guests or those who have previously visited the area [context characteristic], the generated map might have simpler information-related tonal characteristics, focusing on the wedding venue, nearby hotels, and basic landmarks. The tonal characteristics of text in the digital content could be concise and direct, assuming a degree of familiarity with the area. The system could highlight alternative routes for avoiding traffic based on real-time data and display them prominently on the map. In the description, the map may say things like, "As you know, Elm Street can get congested during rush hour, so consider taking Maple Avenue."

Conversely, for guests who are newcomers to the area [context characteristic], the generated map might have more detailed informational tonal characteristics, including key points of interest, recommended restaurants, and transportation options. The tonal characteristics related to written instruction could be more descriptive and explanatory, providing clear guidance and helpful tips. If the system detects from USCD that Emily typically uses a warm, welcoming tone with out-of-town guests, it could include personalized notes on the map, such as "Welcome to our city! We hope you enjoy your stay."

The system might also learn Emily's preferred formatting for maps, such as highlighting locations with specific colors or symbols. For example, if Emily often uses heart symbols to mark her favorite spots, the system could automatically use those symbols on the maps for her wedding guests. The map may say things like, "Welcome! This is one of the best parts of town, with many restaurants and parks."

The system can tailor the UI of the map based on context characteristics, as well. The system may offer options to integrate the map with ride-sharing apps and/or real-time public transportation updates. The system may then personalize the map's appearance to match Emily's wedding theme or color scheme, ensuring that all elements are consistent with her personal style and preferences. The map could also provide links to local emergency services and important contact numbers.

### BRIEF DESCRIPTION OF THE DRAWINGS

FIG. 1 schematically depicts an example environment in which selected aspects of the present disclosure may be implemented, in accordance with various implementations.

FIG. 2 schematically depicts an example of how various components of FIG. 1 may cooperate to conduct selected aspects of the present disclosure, in accordance with various implementations.

FIG. 3 schematically depicts an example of how user interactions from a variety of different sources may be accessible to components such as a user profile engine and a USCD engine to provide USCD, in accordance with various implementations.

FIG. 4 is a flowchart illustrating an example process of performing selected aspects of the present disclosure, in accordance with various implementations.

FIG. 5 schematically depicts an example architecture of a computer system, in accordance with various implementations.

### DETAILED DESCRIPTION

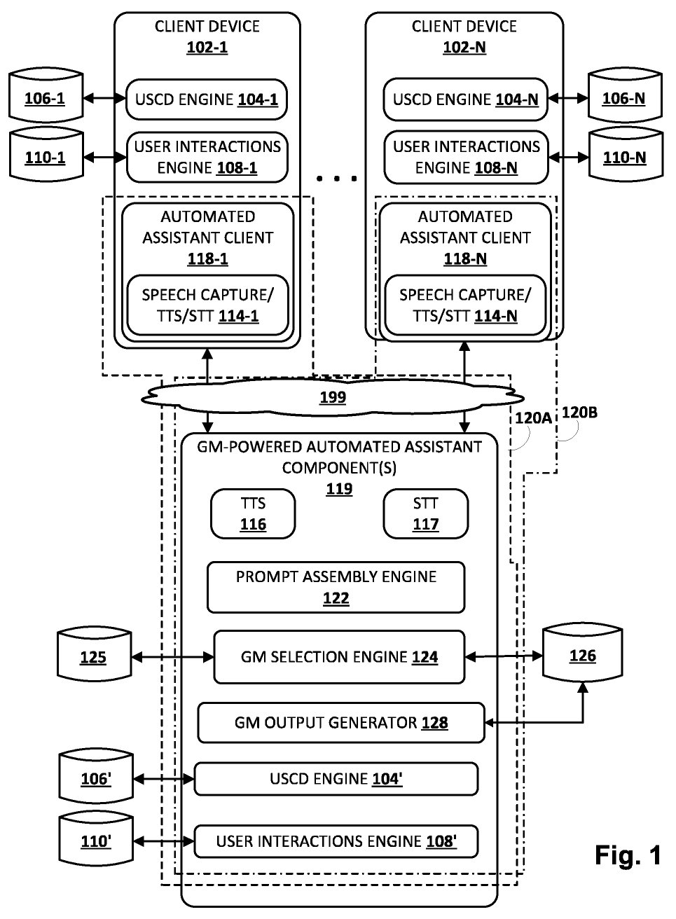

Now turning to FIG. 1, an example environment in which techniques disclosed herein may be implemented is illustrated. The example environment includes a plurality of client computing devices 102-1 to 102-N. Each client device 102 may execute a respective instance of an automated assistant client 118. One or more generative model (GM)-powered automated assistant components 119 may be implemented on one or more computing systems/servers (collectively referred to as a “cloud” computing system) that are communicatively coupled to client devices 102-1 to 102-N via one or more local and/or wide area networks (e.g., the Internet) indicated generally at 199. Moreover, one or more GM-powered automated assistant components 119 might alternatively be implemented at one or more of client devices 102.

An instance of an automated assistant client 118, by way of its interactions with one or more GM-powered automated assistant components 119, may form what appears to be, from the user’s perspective, a logical instance of an automated assistant 120 with which the user may engage in a human-to-computer dialog. Two instances of such an automated assistant 120A, 120B are depicted in FIG. 1 in dashed line. It thus should be understood that each user that engages with an automated assistant client 118 executing on a client device 102 may, in effect, engage with his or her own logical instance of an automated assistant 120. However, other implementations could vary. For example, a single client device 102 could have multiple automated assistant clients 118 (e.g., a different instance for different user profiles or different email profiles).

For the sakes of brevity and simplicity, the term “automated assistant” as used herein as “serving” a particular user will refer to the combination of an automated assistant client 118 executing on a client device 102 operated by the user and one or more GM-powered automated assistant components 119. It should also be understood that in many cases, automated assistant 120 may respond to a request from any user regardless of whether the user is actually “served” by that particular instance of automated assistant 120.

The client devices 102 may include, for example, one or more of: a desktop computing device, a laptop computing device, a tablet computing device, a mobile phone computing device, a computing device of a vehicle of the user (e.g., an in-vehicle communications system, an in- vehicle entertainment system, an in-vehicle navigation system), a standalone interactive speaker, a smart appliance such as a smart television, and/or a wearable apparatus of the user that includes a computing device (e.g., a watch of the user having a computing device, glasses of the user having a computing device, a virtual or augmented reality computing device), a robot, etc. Additional and/or alternative client computing devices may be provided.

In various implementations, an individual communicates with automated assistant 120 utilizing any one of a plurality of client computing devices that collectively form a coordinated ecosystem of client computing devices. In some cases, the coordinated ecosystem of client devices may be linked to the individual via a user profile of the individual that is associated with, for example, the individual’s email address. In some such implementations, the individual’s USCD may also be linked with this same profile, so that the individual’s USCD may be used when the individual operates any client device of their coordinated ecosystem to interact with automated assistant 120, or more generally, to interact with generative model(s).

Automated assistant 120 engages in human-to-computer dialog sessions with a user via user interface input and output devices of one or more client devices 102-1 to 102-N. To preserve user privacy and/or to conserve resources, in many situations a user must often explicitly invoke the automated assistant 120 before the automated assistant will fully process a spoken utterance. The explicit invocation of the automated assistant 120 can occur in response to certain user interface input received at the client devices 102. For example, user interface inputs that can invoke the automated assistant 120 via the client devices 102 can optionally include actuations of a hardware and/or virtual button of the client device 102. In some implementations, the automated assistant client may include a component 114 that is configured to capture the user's utterance and either convert it to text using speech to text (STT)) processing, or in some cases, convert the audio directly into semantically rich embeddings, e.g., using an end-to-end transformer-based architecture (with text being generated, if at all, as a byproduct). The component 114 may also include text to speech (TTS) functionality for converting text (or embeddings) to synthetic audio such as speech. For example, textual content received from GM-powered automated assistant components 119 may be processed using the TTS functionality of component 114 and output as audio content using one or more speakers. Although not explicitly shown for the sake of reducing clutter in the various Figures, in some implementations a client device 102 could additionally or alternatively include one or more tools configured to generate video content based on textual or audio content, and/or some other similar tool.

Client devices 102-1 to 102-N may also include user-specific conditioning data (USCD) engines 104-1 to 104-N and user interactions engines 108-1 to 108-N that are operably coupled, directly or indirectly, with user-specific conditioning (USCD) databases 106-1 to 106-N and user interactions databases 110-1 to 110-N, respectively. Additionally or alternatively, in some implementations, cloud-based instances of these components may be provided. For instance, there may be a cloud-based USCD engine 104’, a cloud-based USCD database 106’, a cloud-based user interactions engine 108’, and/or a cloud-based user interactions database 110’. Anytime any of the reference numerals 104 to 110 are used herein without any additional context (e.g., “-1” or a single quote), that may refer to either the local instance (e.g., 104-1, 106-1, 108-1, 110-1) or the cloud-based instance (e.g., 104', 106', 108', 110').

USCD engine 104 may be configured to build and/or maintain USCD for each user based on data received from user interactions engine 108 and/or from other sources, such as automated assistant client 118. USCD may be indicative of a wide variety of an individual's attributes, including but not limited to preferences, observed behavior, content of electronic correspondence, smart appliance configurations, user-centric coordinated ecosystems of computing devices, schedules, travel history and/or any combination thereof. As noted elsewhere herein, individuals may have complete control over which user interactions (and hence, which of their attributes) are incorporated into their USCD, and which user interactions are not.

While the USCD can be described above with respect to a variety of attributes, for the sake of discussion of implementations herein, such discussion will be generalized to attributes such as context characteristics and tonal characteristics. As previously noted, context characteristics can include or relate to characteristics or attributes that are identified based on an intended recipient of a message that is to be generated at least partially by the automated assistant 120. For example, context characteristics can include or relate to elements such as an identity of the recipient, a type of relationship between the user and the recipient(s), a language spoken by the user and/or the recipient(s), the subject matter of the digital content, the method of delivery of the digital content (i.e., a text message, an email, or a professional memorandum), history of the recipient(s), access level of the recipient(s), expertise of the recipient(s), etc. In some implementations, the concept of context characteristics could additionally or alternatively be referred to as a "relational characteristic" or a "recipient characteristic." These terms and examples are provided as non-limiting examples to assist with understanding the concept of "context characteristic." Various implementations can include additional and/or alternative context characteristics.

Similarly, as previously noted, tonal characteristics can be or include characteristics of digital content (i.e., "writing tone" or "writing style" elements) such as the use of emojis, the use of humor, the degree of conciseness or professionalism, the use of nicknames as opposed to formal names, specific vocabulary choice, the use of bulletpoints or full sentences, the types of or degree of detail for presented information, etc. Again, these terms and examples are provided as non-limiting examples for the sake of understanding the concept of "tonal characteristic." Various implementations can include additional and/or alternative tonal characteristics.

In some implementations, the USCD can additionally store indications of one or more correlations between one or more of the tonal characteristics and one or more of the context characteristics. For example, the USCD can include an indication of a relationship between a context characteristic such as the recipient being a supervisor of the user, and one or more tonal characteristics such as a formal and concise writing style. As another example, the USCD can include an indication of a relationship between a context characteristic such as the recipient being a close friend and one or more tonal characteristics such as the frequent use of emojis and a casual tone. As another example, the USCD can include an indication of a relationship between a context characteristic such as the intended delivery method being email and one or more tonal characteristics such as longer, more detailed sentences as opposed to the short, clipped sentences more typically used in text messages. As another example, the USCD can include an indication of a relationship between a context characteristic such as the recipient speaking a certain language and one or more tonal characteristics such as the use of vocabulary that is common in communications with speakers of that language. It will again be understood that the above-described examples are provided as non-limiting examples for the sake of understanding how various ones of the context characteristics can be correlated with various ones of the tonal characteristics. It will be understood that, in various implementations, one or more of the above-described correlations might not exist. Similarly, some implementations can include additional and/or alternative correlations. In some implementations, a context characteristic can be correlated with a plurality of tonal characteristics. Similarly, in some implementations, a tonal characteristic can be correlated with a plurality of context characteristics.

In some implementations, various of the context characteristics and/or tonal characteristics may overlap with respect to the correlations such that tonal characteristic(s) related to a context characteristic of a first recipient can be applied to a second recipient that shares a similar or identical context characteristic. To use a particular example, presume that user Frank has two supervisors, George and Henry. Frank might have had multiple previous email discussions with George regarding a certain topic, and so the USCD might have various tonal characteristics related to that topic such as vocabulary used, conciseness and formality, etc. Now, presume that Henry asks the user for information regarding the same topic. In this situation, the system might identify several context characteristics for the response to Henry such as "Henry," "supervisor," and "topic." The system might not have examples of conversations between Frank and Henry regarding the topic, however, the USCD might have several examples of conversations between Frank and George regarding the topic. As such, the tonal characteristics for the response might include tonal characteristics that are correlated to the context characteristic of "Henry" based on previous emails between Frank and Henry. The tonal characteristics might include tonal characteristics correlated to the context characteristic of "supervisor" based on previous conversations between Frank and Henry, as well as previous conversations between Frank and George. Finally, the tonal characteristics might include tonal characteristics correlated to the context characteristic of "topic" based on previous conversations between Frank and George. The system can then combine these various tonal characteristics to generate an email to George regarding the topic.

USCD engine 104 may store USCD in USCD database 106 in various forms and/or modalities, such as natural language text, structured text such as extensible markup language (XML) or JavaScript Object Notation (JSON), semantically-rich embeddings/tokens, images, videos, and/or any combination thereof. In various implementations, USCD engine 104 may represent user interactions in USCD in different ways. For example, USCD engine 104 may incorporate data indicative of new user interactions into USCD in raw form, whereas previous user interactions may be summarized in the USCD as text/embeddings. In some instances, those new user interactions may be subsequently summarized into text/embeddings when convenient/during downtime. In some implementations, USCD engine 104 or other components herein may formulate USCD to be condensed relative to raw data from which it is derived. For instance, electronic correspondence and/or textual documents consumed by an individual may be summarized using generative model(s) into abridged textual summaries and/or encoded into reduced-dimensionality embedding(s) before being stored as USCD in database 106.

In some implementations, USCD stored in USCD database 106 may be associated with various metadata. This metadata may include, for instance, mappings between portions of the USCD and the underlying user interactions (e.g., raw data) that spawned those portions of the USCD, which are described elsewhere herein. Additionally or alternatively, in some implementations, the metadata associated with USCD may include timestamps of when, for instance, those portions were added to the USCD or last modified. In some instances, these timestamps may be used as mappings between portion(s) of the USCD and an underlying user interactions timeline that is stored, for instance, in user interactions database 110. The USCD metadata may additionally or alternatively include confidence measures associated with individual pieces of data. For instance, a search engine query seeking vegetarian restaurants may be assigned less confidence than an explicit statement from an individual that he or she is a vegetarian. This may be because, for instance, the search engine query is capable of multiple interpretations, such as the individual was seeking a restaurant for a vegetarian friend or colleague. The explicit statement is less ambiguous, and therefore may be assigned a greater confidence measure.

In addition, the metadata may indicate context characteristics, such as the intended recipient's role or relationship to the user, tonal characteristics, such as the level of formality or use of humor, and the relationship between the two (e.g., "formal tone when communicating with supervisor"). The system can also maintain a confidence score for these relationships. For example, if the system has limited data on a new contact, it might have a low confidence score regarding whether that contact is a professional colleague or a personal friend. This confidence score can influence how strongly the system biases the generated response towards a particular writing style. If the confidence score is low, the system may rely more heavily on general patterns in the user's writing, while if the confidence score is high, it may more closely mimic the user's communication style with similar contacts.

In such cases, the system might employ a default set of tonal characteristics if the confidence regarding one or more of the context characteristics are below a given threshold. For example, in this case, the system might default to a more formal writing style with full sentences, avoiding slang or colloquialisms. In other instances, if the system struggles to discern a level of confidence regarding one or more context characteristics, the system might default to a neutral tone, ensuring the generated message remains professional and avoids unintended misinterpretations. The system may, for example, err on the side of avoiding humor or emojis, or it may err on the side of a more concise or terse writing style, depending on the particular implementation and context. Maintaining these confidence scores can allow the system to gracefully handle ambiguous situations and provide a reasonable and contextually appropriate response, even when certain context characteristics are not definitively identified. Again, the above examples are provided as non-limiting examples for the sake of discussion only, and other implementations can include additional and/or alternative default tonal characteristics.

In many implementations, USCD engine 104 may be required to solicit explicit and/or implicit permission from individuals prior to storing data received from user interactions engine 108 as part of USCD in USCD database 106. For example, USCD engine 104-1 may cause client device 102-1 to audibly and/or visually prompt the individual to expressly indicate their willingness to have data provided as USCD by USCD engine 104 and/or user interactions engine 108 be stored by USCD engine 104 in USCD database 106. By opting into such use of their personal data, the individual's privacy and/or security in using such data is maintained. Additionally or alternatively, in some implementations, an individual's USCD may be encrypted before being transmitted to GM-powered automated assistant components 119 and/or shared with other components, such as the cloud-based USCD engine 104’ and corresponding cloud-based USCD database 106’, or the cloud-based user interactions engine 108’ and corresponding cloud-based user interactions database 110’.

In various implementations, and with the individual's express permission, user interactions engines 108 may be configured to monitor various types of user interactions between the individual and one or more computing devices 102-1 to 102-N, and store data indicative of relevant interactions in user interactions database 110. In other implementations, USCD engine(s) 104 may handle all functions attributed herein to user interactions engine(s) 108, and user interactions engine(s) 108 may be omitted.

As one example, user interactions engine 108 (or USCD engine 104 in some implementations) may monitor emails, text messages, and/or other forms of electronic content sent, e.g., via network 199, by user device 102-1. In some implementations, the user interactions engine 108 (or USCD engine 104 in some implementations) might monitor for received content as well. However, for the sake of clarity and readability herein, concepts may be presented using phrasing only related to content generated by, rather than received by, the user. Such presentation is not intended to limit the USCD to only such content. For example, if the user is a supervisor of another person, and that person sends an email to the user, then tonal characteristics of that email may be stored in the USCD for use in generating an email to the user's supervisor.

In some implementations, the user interactions engine 108 may additionally or alternatively monitor non-textual content that is generated by the user, received by the user, or that is related to the user. Such content could involve a user’s interaction with one or more household automated assistants, pictures or video, songs listened to by the user, voice memos or direct audio input to or from the user, etc. Generally, it will be understood that the above descriptions of the various sources of content that can be used to generate USCD is intended to be non-limiting examples of such sources, and various other sources can be used in addition to, or instead of, one or more of the described textual or non-textual sources.

As yet another example, user interactions engine 108 (or USCD engine 104 in some implementations) may monitor user preferences and/or other user feedback explicitly submitted by the user, e.g., via automated assistant client 118 or otherwise. For example, the user interactions engine 108 (or USCD engine 104 in some implementations) might monitor user feedback provided to the system to explicitly indicate a preference, such as upvoting or downvoting a generated response or otherwise rating its quality.

To further enhance personalization, the system (e.g., via the automated assistant client 118 or otherwise) can allow users to provide explicit examples of context characteristics, tonal characteristics, and the correlations between them. Non-limiting examples could involve allowing a user to directly specify:

"When communicating with my supervisor [context characteristic], always use email and maintain a formal tone [tonal characteristic]."

"For my friend Sarah [context characteristic], only use text messages and never use emojis [tonal characteristic]."

"When messaging my family group chat [context characteristic], use slang terms like 'LOL' and include several emojis [tonal characteristics]."

In various implementations, users could be allowed to provide this feedback through various means. Non-limiting examples of such provision could include:

Document Submission: Providing example emails, documents, or other written communications that exemplify the user's desired style for specific contexts. Such provision could take the form of uploading one or more documents, providing access to the documents on a local or network drive, providing a URL for such documents, etc.

Non-Textual Content Submission: Providing other digital content or digital interactions that are to or from the user, or that otherwise involve the user. This digital content could come from a variety of sources such as the user’s calendar, the user’s photo reel, etc. In some implementations, the digital content could be photographs, movies, songs, voice memos, direct audio input etc.

Explicit Instruction: Using a settings interface to directly define context characteristics, tonal characteristics, and their relationships (e.g., check boxes or text-entry boxes that allow a user to select a context characteristic such as "clients" and one or more tonal characteristics such as "professional tone" and "avoid contractions.").

Natural Language Feedback: Providing feedback in natural language (e.g., "That response was too formal; I would normally use a more casual tone with this person").

Learning from Corrections: The system can learn from user edits to generated content, adapting its style accordingly. For example, if a user consistently replaces formal language with more casual terms, the system will learn to favor a less formal tone in similar contexts.

Preference Selection: Selecting preferred tonal characteristics from a predefined list for different context characteristics.

By allowing users to explicitly define these relationships, the system can generate even more personalized and relevant content. For example, it can learn to adjust the level of formality, the use of humor, and even the specific vocabulary used based on the recipient and the communication channel. The system can store such explicit feedback in the USCD for future use.

The USCD, as described above, can be used to tailor the generative model's output. There are several ways this USCD can be generated and maintained. As a first option, the system may accept user-input documents (e.g., emails, text messages, documents) directly to create or update the USCD. These documents may be analyzed to identify context characteristics and tonal characteristics.

As a second option, the system can automatically or semi-automatically crawl user-provided sources, such as email accounts, cloud storage drives, social media accounts, photo reels, and/or other sources to which the user has granted access. The system may then analyze the content of these sources to identify patterns in the user's communications, inferring context characteristics and tonal characteristics for inclusion in the USCD. In some embodiments, the system can continuously monitor these sources for new information, updating the USCD in real-time or near-real-time. The USCD can then be pre-generated and stored (e.g., in USCD database 106) for later use.

As a third option, the system may generate the USCD on-demand, for example based on the user's request. In this approach, the system may not pre-generate any USCD. Instead, when the user issues a prompt or request, the system dynamically analyzes available data sources and creates a temporary USCD for that specific interaction. Such an approach may be referred to as retrieval augmented generation (RAG). In this context, RAG can be considered to be a technique that enhances the generative model's knowledge by retrieving information from external sources and incorporating it into the prompt that is incorporated into the GM. In some implementations, the retrieved information could be processed (e.g., summarized, synthesized with data from other resources or locations, etc.) prior to incorporation into the GM. Instead of relying solely on the data the model was trained on, RAG allows the model to access and utilize up-to-date and user-specific information. In this specific implementation, RAG enables the system to fetch relevant examples of the user's past communications, such as emails and documents, and use them to inform the generation of personalized content. By grounding the model's output in the user's own data, RAG ensures that the generated content is more relevant, accurate, and aligned with the user's writing style and preferences. This approach can also allow the system to access private user data without retraining the entire model or compromising user privacy.

It will be understood that the above-described three options are intended as non-limiting examples of such options, and other embodiments can include one or more additional and/or alternative ways of generating the USCD.

Similar to USCD engine 104, in various implementations, user interactions engine 108 may be required to solicit explicit and/or implicit permission from an individual prior to monitoring user interaction(s) between the individual and computing devices 102-1 to 102-N and storing data indicative thereof in user interactions database 110. For example, user interactions engine 108 may cause client device 102-1 to audibly and/or visually prompt the individual to expressly indicate their willingness to have data provided as user interaction(s) by user interactions engine 108 be stored in user interactions database 110. By being able to opt in and/or out of such use of their personal data, the individual's privacy and/or security in using such data is maintained. In some implementations, an individual's user interaction(s) may be stored only in local user interactions database 110, or may be encrypted before being transmitted to GM-powered automated assistant components 119 and/or shared with other components.

GM-powered automated assistant component(s) 119 may include a text-to-speech (TTS) component 116, a speech-to-text (STT) component 117, a prompt assembly engine 122, a GM selection engine 124, a classifier 125, a GM output generator 128, a cloud-based USCD engine 104' and corresponding database 106’, and a cloud-based user interactions engine 108’ and corresponding user interactions database 110’. TTS component 116 may be configured to leverage the virtually limitless resources of the cloud computing system to convert textual data (e.g., natural language responses formulated by automated assistant 120) into computer generated speech output. In some implementations, TTS component 116 may provide the computer generated speech output to client device 102 to be output directly, e.g., using one or more speakers. TTS component 116 may use any appropriate speech synthesis technique to generate computer generated speech output from textual data including, but not limited to, concatenative synthesis, unit selection synthesis, diphone synthesis, domain-specific synthesis, formant synthesis, Hidden Markov Model (HMM)-based synthesis (e.g., Gaussian mixture core network synthesis), sinewave synthesis, or any combination thereof. In some implementations, the TTS component 116 may be implemented using an end-to-end transformer-based architecture.

STT component 117 may be configured to convert a spoken utterance into text data. In some implementations, STT component 117 may convert an utterance into multiple text segments, e.g., phonemes, word pieces, etc., that are string of characters corresponding to the utterance. STT component 117 may convert the utterance into text data using various speech recognition techniques, such as HMM techniques, dynamic time warping (DTW)-based techniques, neural network-based techniques, or other techniques. In some implementations, the STT component 117 may be implemented using an end-to-end transformer-based architecture.

Prompt assembly engine 122 may be configured to assemble generative model prompts (or "context") that can then be used by GM selection engine 124 to select one or more GMs from GM database 126, and that can be used by GM output generator 128 to generate generative model output. Prompt assembly engine 122 may assemble generative model prompts from various data sources, such as a user’s explicit or implicit generative model query. An explicit generative model query may be issued via the user typing or speaking the query. An implicit generative model query may be issued automatically, e.g., in response to various events that may occur in a software application, in response to particular sensor data, etc.

In addition to an individual's explicit or implicit generative model query, prompt assembly engine 122 may assemble other data into a generative model prompt. For example, prompt assembly engine 122 may assemble data indicative of the individual's USCD, received from cloud-based USCD engine 104' or a local USCD engine 104-1 to 104-N into the generative model prompt. In some implementations, a cloud-based USCD engine 104' may obtain this USCD from database 106-1 of client device 102-1 and may temporarily store it in a cloud-based USCD database 106'. Additionally or alternatively, cloud-based USCD engine 104' may store individuals' USCD data in cloud-based USCD database 106' on a long term basis, while taking steps to ensure the privacy and security of the individuals' USCD. In some such implementations, the individuals may be required to provide express permission before their USCD can be stored in cloud-based USCD database 106'. Additionally or alternatively, in some implementations, USCD stored in database 106' (or locally at 106) may be stored in a form that is not readily interpretable by humans, such as in continuous embedding form, encrypted form, hashed form, etc.

As noted above, GM selection engine 124 may be configured to select one or more generative models 126 that are suitable for generating content responsive to, for instance, an individual's generative model query (or even to a generic search query), to an implicit query, and/or to a request to update an individual’s USCD based on new user interaction(s). In some implementations, GM selection engine 124 may utilize a classifier 125 to identify a generative model that is most likely to accurately and efficiently respond to a generative model query provided by automated assistant 120 and an individual that provided the generative model query. Such a classifier may itself be a generative model (e.g., an LLM), or it may be another type of machine learning model that is trained to classify or otherwise generate scores for different available generative models 126. As one example, if an individual's query includes both text and an image (e.g., “modify this image to delete the clouds”), the GM selection engine 124 may select a generative model that is suitable for generating synthetic image data, such as a diffusion model. Additionally or alternatively, GM output generator 128 may include a plurality of generative model agents, each configured to perform different task(s) using different generative models, and the GM selection engine 124 may select the most suitable GM agent.

GM output generator 128 may be configured to process a prompt using one or more generative models selected by GM selection engine 124 from GM database 126 (GM database and generative models themselves will both be interchangeably referenced using 126) to generate content that is responsive to, for instance, a generative model query from automated assistant client 118 at a client device 102, or to an implicit query to update an individual’s USCD based on new user interaction(s). To this end, GM output generator 128 may have access to one or more generative models in database 126, and may apply those generative model(s) that are selected by GM selection engine 124.

GM database 126 may include a variety of generative models, such as foundation models, fine-tuned models, and task-specific models. Foundation models may be pretrained on large datasets of various types of data, such as text, code, images, videos, audio, etc. Foundation models can be used for a wide range of tasks. Fine-tuned models are foundation models that have been further trained on a specific dataset, such as a dataset of customer service conversations or a dataset of medical records. Task-specific models are designed for a specific task, such as generating code, translating languages, or writing different kinds of creative content. Generative models can be single-modal or multi-modal. Single-modal models process and generate data of a single type, such as text or images. Multi-modal models such as vision-language models (VLMs) process and/or generate data of multiple types, such as text and images, or text and audio. Generative models may or may not be transformer-based, and may be encoder-only, decoder-only, or encoder-decoder. Encoder-only models take an input and produce a representation of that input. Decoder-only models take a representation and produce an output. Encoder-decoder models combine both encoder and decoder components. Some generative models that generate non-textual data may include, for instance, stable diffusion models.

The number of parameters in a generative model can vary significantly depending on the model's complexity and the resources available for its implementation. On a resource-constrained client device like 102, the model may have a smaller number of parameters to optimize performance and reduce memory usage. This is because client devices often have limited processing power and memory compared to cloud servers. In contrast, a generative model implemented on a cloud server like 119 can have a much larger number of parameters due to the availability of extensive computing resources. This allows for more complex models with higher accuracy and capabilities. The choice of parameter size is a trade-off between model performance and resource constraints. For example, on a client device with limited resources, a generative model might have 100 million parameters, while a server-based model could have billions of parameters, enabling more complex and accurate results. Another example is a client device model with 500 million parameters, compared to a server model with 100 billion parameters, showcasing the significant difference in scale and capabilities.

It will be noted that implementations herein are described with respect to different communication protocols such as text messages, emails, chats, etc. As such, although not explicitly shown in FIG. 1, the client device 102 can have one or more tools or applications running thereon such as a web client, a text message client, an email client, etc. Additional tools such as a calendar, a camera application, etc. could likewise be present on a client device 102. These tools could be used to facilitate the transmission and/reception of various digital interactions to, from, or otherwise involving the user, which could be used as the basis for USCD. Additionally or alternatively, such tools could be used to, for example, draft and/or send an email, draft and/or send a text message, etc.

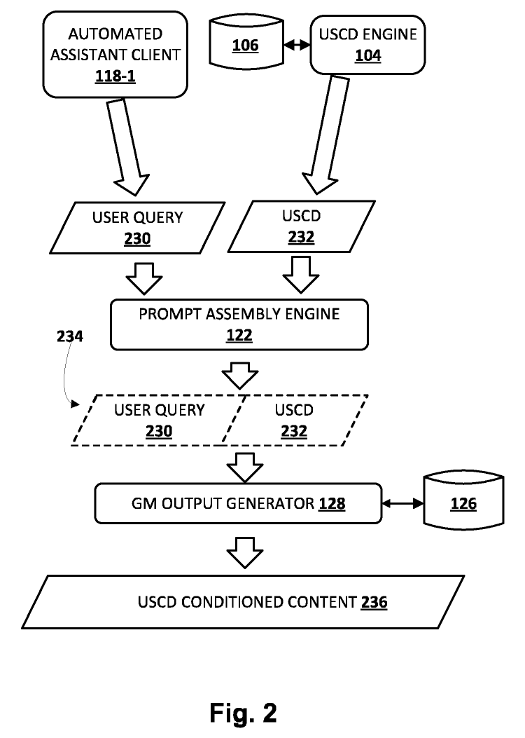

FIG. 2 schematically depicts an example of how various components of FIG. 1 may cooperate to conduct selected aspects of the present disclosure. Beginning at top, USCD engine 104-1 and automated assistant client 118-1 of client device 102-1 may provide, respectively, data indicative of a user-specific conditioning data (USCD) 232 and a user query 230 to prompt assembly engine 122. Prompt assembly engine 122 may then assemble the USCD 232 and the user query 230 into a generative model prompt 234. While not shown in FIG. 2 for the sake of brevity and simplicity, this generative model prompt 234 may be provided to GM selection engine 124, and GM selection engine 124 may select appropriate generative model(s) 126 and/or GM agents for processing this generative model prompt 234.

Moreover, various other information may or may not be assembled into generative model prompt 234 by prompt assembly engine 122. This other information may, for instance, include system instructions (e.g., not provided by the user) on how USCD should be used to personalize or otherwise condition the generative model output. For instance, the system instructions may include a natural language statement such as “When responding to the user’s query, make sure to take into account this summary of the user, including the user’s preferences, attributes, etc.” In some implementations, the system instructions may include additional requests designed to avoid various negative outcomes. For example, the system instructions may include a request such as “Medical data of the user should not be disclosed to anyone other than the user. Accordingly, don’t directly incorporate the user’s medical data into your response. At most, allow the user’s medical data to influence other output you generate, without explicitly mentioning the medical data itself.”

Referring back to FIG. 2, prompt assembly engine 122 (or GM selection engine 124) may provide generative model prompt 234 to GM output generator 128. GM output generator 128 may then input the generative model prompt 234 into one or more generative models of GM database 126 to generate output that includes USCD-conditioned content 236. USCD conditioned content 236 may include content that is both responsive to user query 230 and conditioned upon USCD 232. For example, in accordance with various implementations herein, the USCD-conditioned content 236 can include one or more written communications such as an email, a text message, a memorandum, a document, and/or some other type of written communication that is responsive to the user query 230.

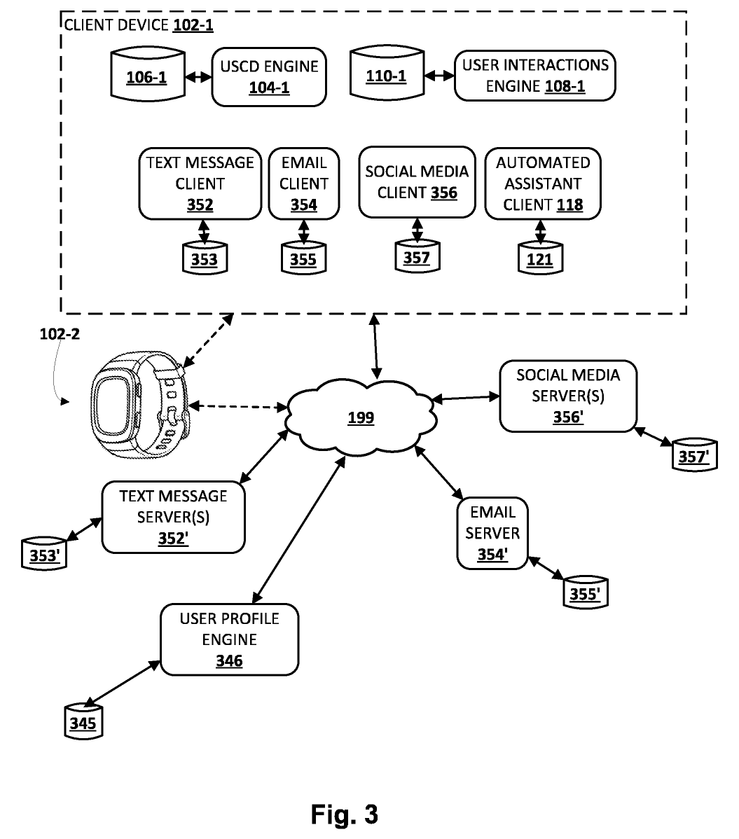

FIG. 3 schematically depicts an example of how a text-based interactions (i.e., written documents, emails, text messages, etc.) from a variety of different sources can be accessible to components such as local user interactions engine 108-1 (or a cloud-based user interactions engine 108’ such as that depicted in FIG. 1), USCD engine 104-1 to 104-N (or cloud-based USCD engine 104’ in FIG. 1), and/or to a user profile engine 346, to generate and/or update USCD based on changes to user interactions made by individuals. The components depicted in FIG. 3 are for illustration only and are not meant to be limiting. Additional components not depicted in FIG. 3 may additionally or alternatively provide additional material that can be incorporated into and/or deleted from USCD as described herein. For example, as described, in some implementations non-textual digital content can likewise be used to generate USCD. Such non-textual digital content can be or include audio content, video content, image content, and/or some other type of content as previously described. However, for the sake of providing a clear and concise example of one implementation, this example will be provided solely with respect to written content to enhance readability and clarity.

In some implementations, one or more components depicted in FIG. 3 may be omitted and/or combined with other components of FIG. 3. In FIG. 3, a single client device 102-1 is depicted as being operably coupled to various cloud-based components via one or more networks 199, but it should be understood that numerous other client devices be present in other implementations.

Client device 102-1 may include various local sources of user text-based interactions. A text message client 352 can provide examples of text messages written by the user to others. Example formats could include, for example, short message service (SMS) messages, multimedia message service (MMS) messages, and various proprietary formats such as those that may be used to communicate between users of a social network via a messaging service related to that social network. In some implementations, the text message client 352 may include a database 353 that can include various stored messages provided by the user.

Email client 354 may be operable by the individual to send and/or receive email messages. Email client 354 may include a local email database 355 that may include, for instance, previously received and/or sent email messages and/or message threads.

A social media client 356 may provide an interface by which a user can interact with a social media network. Social media client 356 can include a local cache or database 357 which can include, for instance, cached or saved data related to a user's posts and/or a user's personal profile or page that could include samples of the user's writing style.

Not all sources of user interactions are necessarily stored locally at client devices 102-1 to 102-N. In some implementations, various cloud-based resources may be used to generate data related to context characteristics and/or tonal characteristics that can be selectively incorporated into and/or removed from USCD. For example, a user profile engine 346 may be configured to detect and/or maintain a user profile for an individual, e.g., in association with their email address. A user profile may include, for instance, general user profile data 345 such as an individual's name, age, address, general preferences explicitly provided by the individual, configuration data for a coordinated ecosystem of client devices registered to and/or under the control of a particular user, and so forth.

Email client 354 may interact with an email server 354'. Email server 354' may be configured to store and/or organize, in a cloud-based email database 355’, a superset of email messages that is synchronized with and/or considerably larger than a subset of those messages stored locally to email database 355. Similarly, text message client 352 may interact with one or more text message servers 352'. The one or more text message servers 352' can include a text message database 353' that may include text messages of the user that are not present on the user's client device 102-1 if, for example, the user had previously deleted various messages (either through an affirmative action to do so, or passively such as deletion based on a time-based threshold). Similarly, the social media client 356 may interact with one or more social media server(s) 356' which may include a database 357' that could be configured to store additional data related to the user's social media posts and/or the social media network in general.

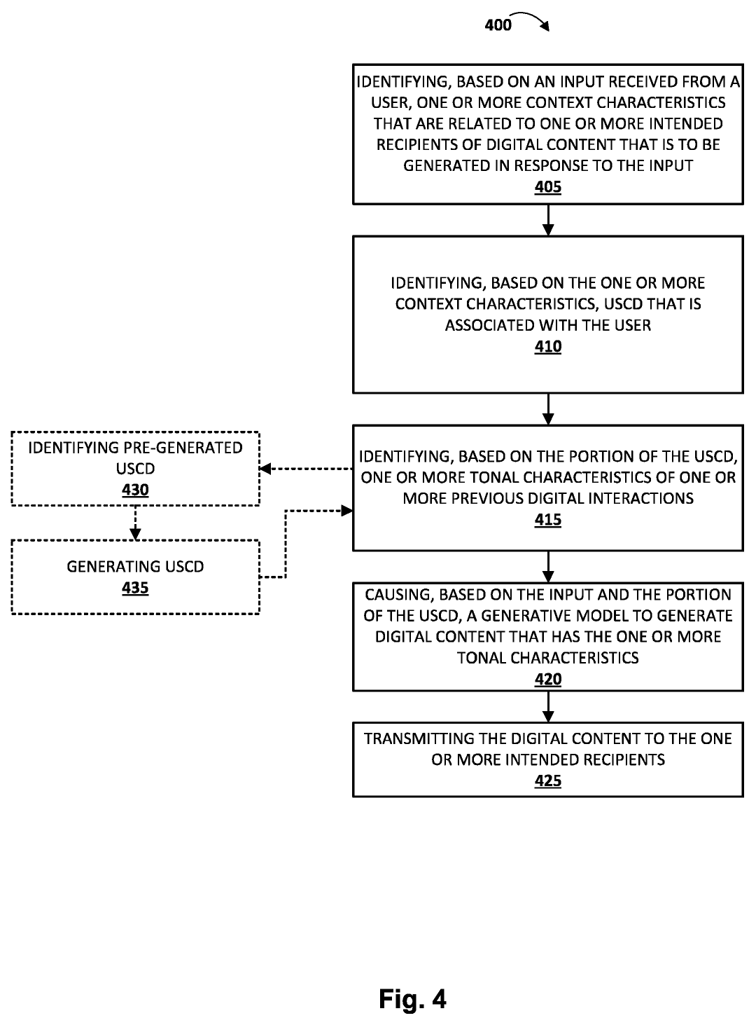

FIG. 4 is a flowchart illustrating an example process of performing selected aspects of the present disclosure, in accordance with various implementations. As previously described, the process 400 may be performed, in whole or in part, by elements depicted in FIG. 1 such as a USCD engine 104, a user interactions engine 108, and/or one or more additional or alternative elements. It will be understood that the process of FIG. 4 is depicted as an example of such a process, and other implementations can include one or more additional or alternative elements. In some implementations, one or more of the elements of the process 400 can be performed in an order that is different than depicted in FIG. 4. Other implementations can include various other differences that what is depicted in FIG. 4.

At block 405, the process 400 may include identifying, based on an input received from a user, one or more context characteristics that are related to one or more intended recipients of digital content that may be generated in response to the input. The one or more intended recipients are different than the user. As discussed previously, the user may interact with the automated assistant 120 executing on a client device 102 to provide the input.

At block 410, the process 400 may further include identifying, based on the one or more context characteristics, user-specific conditioning data (USCD) that is associated with the user. The USCD may be based on one or more previous digital (e.g., written or non-written) interactions of the user with one or more electronic devices. The previous digital interactions could be identified based on the context characteristics related to the recipient of intended recipients. As previously discussed, in some implementations identification of the USCD can optionally include identifying pre-generated USCD at 430, for example as could be generated by crawling through various authorized documents / emails / text messages / photos /videos / voice memos / chats / etc. of a user or by analyzing similar content that has been explicitly provided by the user. In some implementations, identification of the USCD could additionally or alternatively include generating the USCD at 435, for example based on the input from the user. The USCD may be stored in USCD database 106, as previously discussed. The user interactions engine 108 may be configured to monitor the interactions, as previously discussed.

At block 415, the process may further include identifying, based on the portion of the USCD, one or more tonal characteristics of the one or more previous digital interactions. The one or more tonal characteristics may be associated with the one or more context characteristics.

At block 420, the process may further include causing, based on the input and the portion of the USCD, a generative model to generate digital content that has the one or more tonal characteristics. The GM output generator 128, as shown in FIG. 1, may be used in generating the message.

At block 425, the process may further include transmitting the digital content to the one or more intended recipients. For example, the digital content could be transmitted via email, by text message, etc. In some implementations, prior to the transmission, the digital content and/or portions thereof could be rendered to the user for user approval or editing. For example, if the user provided an edit to the content, then such an edit could be used to generate USCD at 435 and/or be used as a new input to iterate the process beginning at 405.

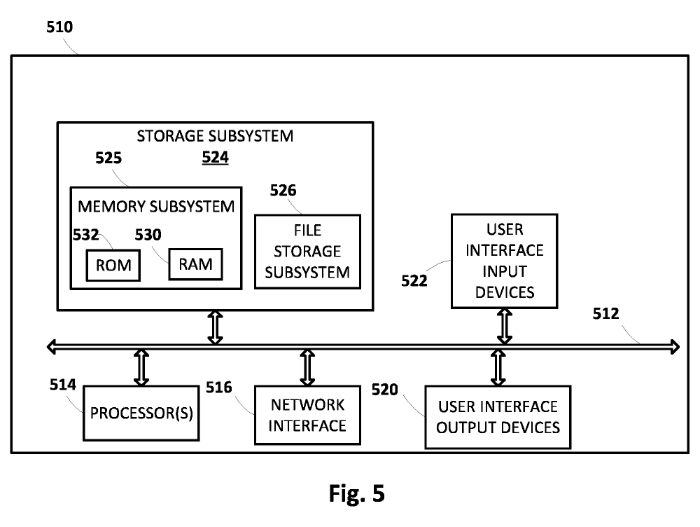

FIG. 5 is a block diagram of an example computer system 510. Computer system 510 typically includes processor(s) 514 which communicates with a number of peripheral devices via bus subsystem 512. These peripheral devices may include a storage subsystem 524, including, for example, a memory subsystem 525 and a file storage subsystem 526, user interface output devices 520, user interface input devices 522, and a network interface subsystem 516. The input and output devices allow user interaction with computer system 510. Network interface subsystem 516 provides an interface to outside networks and is coupled to corresponding interface devices in other computer systems.

User interface input devices 522 may include a keyboard, pointing devices such as a mouse, trackball, touchpad, or graphics tablet, a scanner, a touchscreen incorporated into the display, audio input devices such as voice recognition systems, microphones, and/or other types of input devices. In general, user interface input devices 522 may include any device for inputting information into computer system 510.

User interface output devices 520 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, user interface output devices 520 may include any device for outputting information from computer system 510 to the user or to another machine or computer system.

Storage subsystem 524 stores programming and data constructs that provide the functionality of some or all of the modules described herein. For example, the storage subsystem 524 may include the logic to perform selected aspects of the method of FIG. 4. These software modules are generally executed by processor(s) 514 alone or in combination with other processors. Processor(s) 514 may take various forms, such as a central processing unit (CPU), a graphics processing unit (GPU), a tensor processing unit (TPU), a neural processing unit (NPU), and so forth.

Memory 525 used in the storage subsystem 524 can include a number of memories including a main random access memory (RAM) 530 for storage of instructions and data during program execution and a read only memory (ROM) 532 in which fixed instructions are stored. A file storage subsystem 526 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 526 in the storage subsystem 524, or in other machines accessible by the processor(s) 514.

Bus subsystem 512 provides a mechanism for letting the various components and subsystems of computer system 510 communicate with each other as intended. Although bus subsystem 512 is shown schematically as a single bus, alternative implementations of the bus subsystem may use multiple busses.

Computer system 510 can be of varying types including a workstation, server, computing cluster, blade server, server farm, or any other data processing system or computing device. Due to the ever-changing nature of computers and networks, the description of computer system 510 depicted in FIG. 5 is intended only as a specific example for purposes of illustrating some implementations. Many other configurations of computer system 510 are possible having more or fewer components than the computer system depicted in FIG. 5.

In situations in which the systems described herein collect personal information about users, or may make use of personal information, the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used. Moreover, features described herein may be activated, deactivated, and reactivated at the individual’s discretion.

In some implementations, a process implemented by processor(s) is provided and includes identifying, based on an input received from a user, one or more context characteristics that are related to one or more intended recipients of digital content that is to be generated in response to the input. The one or more intended recipients are different than the user. The process includes identifying, based on the one or more context characteristics, user-specific conditioning data (USCD) that is associated with the user. The USCD is based on one or more previous digital interactions of the user with one or more electronic devices and the previous digital interactions are related to the one or more context characteristics. The process includes identifying, based on the portion of the USCD, one or more tonal characteristics of the one or more previous digital interactions. The one or more tonal characteristics are associated with the one or more context characteristics. The process includes causing, based on the input and the portion of the USCD, a generative model to generate digital content that has the one or more tonal characteristics. The process includes transmitting the digital content to the one or more intended recipients.

In some implementations, the process can further include identifying the one or more previous digital interactions based on the one or more context characteristics, and the USCD can be generated based on the one or more previous digital interactions.

In some implementations, the one or more context characteristics can relate to a relationship between the user and the one or more intended recipients.

In some of those implementations, the relationship can be a professional relationship.

In some of those implementations, the relationship can be a personal relationship.

In some implementations, the one or more context characteristics can relate to a language spoken by the user or the one or more intended recipients.

In some implementations, the one or more context characteristics can relate to a process of delivery to be used to transmit the digital content.

In some implementations, the one or more previous digital interactions can include a previous written message sent to the one or more intended recipients.

In some implementations, the one or more previous digital interactions can include a previous written message sent to another recipient that can be different than the one or more intended recipients, and the other recipient can be related to the one or more context characteristics.

In some implementations, the one or more previous digital interactions can include an email at least partially written by the user.

In some implementations, the one or more previous digital interactions can include a document at least partially written by the user.

In some implementations, the one or more previous digital interactions can include a search engine query formulated and/or submitted by or on behalf of the user.

In some implementations, the one or more previous digital interactions can include a social media post of the user.

In some implementations, the tonal characteristic can relate to vocabulary that can be present in the one or more previous digital interactions.

In some implementations, the tonal characteristic can relate to a degree of conciseness in the one or more previous digital interactions.

In some implementations, the tonal characteristic can relate to the use of contractions in the one or more previous digital interactions.

In some implementations, the tonal characteristic can relate to the use of humor in the one or more previous digital interactions.

In some implementations, the tonal characteristic can relate to the use of emojis in the one or more previous digital interactions.

Other implementations may include a transitory or non-transitory computer readable storage medium storing instructions executable by a processor to perform a method such as one or more of the methods described above. Yet another implementation may include a system including memory and one or more processors operable to execute instructions, stored in the memory, to implement one or more modules or engines that, alone or collectively, perform a method such as one or more of the methods described above.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A method implemented using one or more processors, the method comprising:
identifying, based on an input received from a user, one or more context characteristics that are related to one or more intended recipients of digital content that is to be generated in response to the input, wherein the one or more intended recipients are different than the user;
identifying, based on the one or more context characteristics, user-specific conditioning data (USCD) that is associated with the user, wherein the USCD is based on one or more previous digital interactions of the user with one or more electronic devices, and wherein the previous digital interactions are related to the one or more context characteristics;
identifying, based on at least a portion of the USCD, one or more tonal characteristics of the one or more previous digital interactions, wherein the one or more tonal characteristics are associated with the one or more context characteristics;
causing, based on the input and the portion of the USCD, a generative model to generate digital content that has the one or more tonal characteristics; and
transmitting the digital content to the one or more intended recipients.

2. The method of claim 1, wherein the method further comprises:
identifying, based on the one or more context characteristics, the one or more previous digital interactions; and
generating the USCD based on the one or more previous digital interactions.

3. The method of claim 1, wherein the one or more context characteristics relate to a relationship between the user and the one or more intended recipients.

4. The method of claim 3, wherein the relationship is a professional relationship.

5. The method of claim 3, wherein the relationship is a personal relationship.

6. The method of claim 1, wherein the one or more context characteristics relate to a language spoken by the user or the one or more intended recipients.

7. The method of claim 1, wherein the one or more context characteristics relate to a method of delivery to be used to transmit the digital content.

8. The method of claim 1, wherein the one or more previous digital interactions include a previous written message sent to the one or more intended recipients.

9. The method of claim 1, wherein the one or more previous digital interactions include a previous written message sent to another recipient that is different than the one or more intended recipients, wherein the other recipient is related to the one or more context characteristics.

10. The method of claim 1, wherein the one or more previous digital interactions include an email at least partially written by the user.

11. The method of claim 1, wherein the one or more previous digital interactions includes a document at least partially written by the user.

12. The method of claim 1, wherein the one or more previous digital interactions includes a search engine query formulated and/or submitted by or on behalf of the user.

13. The method of claim 1, wherein the one or more previous digital interactions includes a social media post of the user.

14. The method of claim 1, wherein the tonal characteristic relates to vocabulary that is present in the one or more previous written interactions.

15. The method of claim 1, wherein the tonal characteristic relates to a degree of conciseness in the one or more previous written interactions.

16. The method of claim 1, wherein the tonal characteristic relates to the use of contractions in the one or more previous written interactions.

17. The method of claim 1, wherein the tonal characteristic relates to the use of humor in the one or more previous written interactions.

18. The method of claim 1, wherein the tonal characteristic relates to the use of emojis in the one or more previous written interactions.

19. One or more non-transitory computer-readable media comprising instructions that, upon execution of the instructions by one or more processors of an electronic device, are to cause the electronic device to:
identify, based on an input received from a user, one or more context characteristics that are related to one or more intended recipients of digital content that is to be generated in response to the input, wherein the one or more intended recipients are different than the user;
identify, based on the one or more context characteristics, user-specific conditioning data (USCD) that is associated with the user, wherein the USCD is based on one or more previous digital interactions of the user with one or more electronic devices, and wherein the previous digital interactions are related to the one or more context characteristics;
identify, based on at least a portion of the USCD, one or more tonal characteristics of the one or more previous digital interactions, wherein the one or more tonal characteristics are associated with the one or more context characteristics; and
cause, based on the input and the portion of the USCD, a generative model to generate digital content that has the one or more tonal characteristics.

20. A system comprising:
storage to store an indication of an input received from a user; and
one or more processors configured to:
identify, based on the input, one or more context characteristics that are related to one or more intended recipients of digital content that is to be generated in response to the input, wherein the one or more intended recipients are different than the user;
identify, based on the one or more context characteristics, user-specific conditioning data (USCD) that is associated with the user, wherein the USCD is based on one or more previous digital interactions of the user with one or more electronic devices, and wherein the previous digital interactions are related to the one or more context characteristics;
identify, based on at least a portion of the USCD, one or more tonal characteristics of the one or more previous digital interactions, wherein the one or more tonal characteristics are associated with the one or more context characteristics; and
cause, based on the input and the portion of the USCD, a generative model to generate digital content that has the one or more tonal characteristics.
